(19) United States
(12) Patent Application Publication
(10) Pub. No.: US 2020/0355101 A1
(43) Pub. Date: Nov. 12, 2020

(54) SOUND GENERATING DEVICE, VEHICLE EXHAUST SYSTEM AND METHOD OF MANUFACTURING A SOUND GENERATING DEVICE

(71) Applicant: Faurecia Emissions Control Technologies, Germany GmbH, Augsburg (DE)

(72) Inventor: Hannes Steinkilberg, Augsburg (DE)

(21) Appl. No.: 16/765,515

(22) PCT Filed: Nov. 21, 2017
(86) PCT No.: PCT/EP2017/079934

§ 371 Date: Jul. 8, 2020

(51) Int. Cl. F01N 1/06; F01N 13/18; G10K 11/178

(52) U.S. Cl. CPC F01N 1/065; G10K 11/178; F01N 13/1805; F01N 13/1844

(57) ABSTRACT

A sound generating device for a vehicle exhaust system of a motor vehicle includes a housing and a sound generator arranged within the housing. The housing has an upper part, a lower part, and a plug connection for at least one control cable for the sound generator. The plug connection is arranged between the upper part and the lower part. Furthermore, a vehicle exhaust system and a method of manufacturing a sound generating device are disclosed.

### CROSS-REFERENCE TO RELATED APPLICATIONS

This application is the US national phase of PCT/EP2017/079934 which was filed on Nov. 21, 2017.

### FIELD OF THE DISCLOSURE

The disclosure relates to a sound generating device for a vehicle exhaust system, to a vehicle exhaust system comprising a sound generating device, and to a method of manufacturing a sound generating device for a vehicle exhaust system of a motor vehicle.

### BACKGROUND

Exhaust systems are known, in which active sound generating devices are used, by means of which artificially generated sound is fed into the exhaust pipe of the exhaust system in order to change the noise of the vehicle.

To this end, the exhaust noise or the noise generated by the engine can be eliminated or damped by correspondingly opposite-phase sound waves. On the other hand, the impression that the vehicle is a more powerful or sporty motorized vehicle can be created by adding further noises or other sounds.

For this purpose, sound generating devices are usually used in which a sound generator, such as a loudspeaker, is provided. Usually, these sound generating devices consist of a housing in which the sound generator is located. To control the sound generator, it is necessary that a control cable for the sound generator is led out of the housing, or a plug connection is provided on the housing into which a control cable from a control unit can be plugged.

Usually, this plug connection is provided at a specific position on the housing. However, the optimum position of the plug connection on the housing depends on where, or on which side, the sound generating device is installed in the vehicle. It is therefore necessary to provide a separate housing for each position of the sound generating device, which however leads to low economies of scale and thus to increased costs.

### SUMMARY

Thus, there is provided a sound generating device, an exhaust system comprising a sound generating device, and a method of manufacturing a sound generating device, in which the costs of the sound generating device or of the exhaust system can be reduced.

In one example, a sound generating device for a vehicle exhaust system of a motor vehicle, comprises a housing and a sound generator, in particular a loudspeaker arranged within the housing. The housing includes an upper part, a lower part, and a plug connection for at least one control cable for the sound generator, the plug connection being arranged between the upper part and the lower part. The upper part, which may also be referred to as cover, and/or the lower part are formed such that the plug connection can be received in different positions therebetween, for example by recesses on the edges in which the plug connected can be received. Due to the modular design of the housing, the position of the plug connection with respect to the upper part and/or the lower part can be freely selected. This makes it possible to manufacture housings the plug connections of which are located at different positions, but which all use the same components. This increases the number of components and thus reduces the costs, since no special designs are required for the individual installation situations.

The housing has an interior, the plug connection providing an interface from the interior of the housing to the environment of the housing. In particular, the plug connection is a component separate from the upper part and the lower part.

The lower part may include a sound channel for the acoustic connection of the interior of the housing with the vehicle exhaust system.

Preferably, the housing has an adapter on which the plug connection is formed, the upper part being connected to the lower part via the adapter. It is thus possible to easily integrate the plug connection into the housing. The adapter having the plug connection is therefore arranged between the upper part and the lower part.

The adapter and the plug connection can be made in one piece.

Furthermore, the upper part and the lower part are, for example, no longer in contact with each other, as the adapter is arranged between the upper part and the lower part.

The adapter may be welded to the upper part and/or to the lower part, in particular by infrared welding.

In order to simplify assembly, the adapter may have at least one coupling portion, and the upper part and/or the lower part may have a connecting portion associated with the at least one coupling portion. The connecting portion may be connected to the coupling portion in order to fasten the upper part or the lower part to the adapter. For this purpose, the connecting portion and the adapter portion are, for example, formed so as to be complementary.

In one configuration of the disclosure, at least parts of the adapter, in particular the at least one coupling portion, and at least parts of the upper part and/or of the lower part, in particular the connecting portion, are formed rotationally symmetrical about a common axis of symmetry such that the upper part and/or the lower part can be fastened to the adapter in different positions. This may, for example, involve a rotational symmetry of 90° or 180°. In this way, it is possible to specify a specific number of possible positions for the plug connection.

The adapter, for example, spans a plane, the axis of symmetry being perpendicular to this plane.

For a simple fastening, the adapter has an upper coupling portion facing the upper part and a lower coupling portion facing the lower part.

In one embodiment of the disclosure, the adapter has at least one frame, which is in particular formed in a ring shape, as result of which the frame is adapted to be inserted into the housing. The frame can run on the outside of the housing, wherein the frame in particular forms a complete circumference of the housing or the entire outer contour.

The adapter is, for example, designed in one piece.

Preferably, the at least one coupling portion is formed on the frame to further simplify installation.

To ensure rotational symmetry, the frame has a circular or substantially rectangular, especially square outer contour. The corners of the rectangular or square outer contour may be rounded.

In one embodiment of the disclosure, the adapter has a holder for the sound generator, the sound generator being fastened to the housing via the holder. Thus, the position of the sound generator with respect to the plug connection is always the same, as the adapter comprises the holder and the plug connection.

The holder, for example, has a holding portion for the sound generator which is completely surrounded by the frame, thus ensuring that the sound generator is safely stored in the housing. The holding portion may be ring-shaped.

To prevent wearing of the control cable, a cable routing may extend from the holder to the frame, in particular up to the plug connection. Spokes are, for example, provided between the holder and the frame, the cable routing being adapted to form one of the spokes.

In one variant embodiment, the holder and the frame are in the same plane, making the adapter very compact. The axis of symmetry is, for example, perpendicular to this plane.

The adapter and the sound generator may form a unit, in particular be made in one piece. The housing of the sound generator is thus coupled to the adapter. In particular, the housing and the adapter are formed in one piece and have, for example, been manufactured together in an injection molding process. In other words, the adapter may be referred to as a part of the sound generator, in particular as a part of the housing of the sound generator.

Furthermore, a vehicle exhaust system is provided that comprises a sound generating device according to the disclosure and an exhaust pipe, the exhaust pipe being acoustically connected to the sound generating device, in particular being acoustically connected to an interior of the housing via a sound channel.

An acoustic connection here means that airborne sound waves can pass from the interior into the exhaust pipe, an oscillating membrane, which is, for example, arranged in the sound channel, being not regarded as disturbing for an acoustic connection, although such a membrane does not allow air to pass through.

A method of manufacturing a sound generating device for a vehicle exhaust system of a motor vehicle is also provided, in which a lower part, an upper part, and an adapter having a plug connection are provided, wherein at least the adapter is aligned with respect to the lower part and/or the upper part such that the plug connection is provided on a desired side of the sound generating device to be manufactured, and wherein the adapter is placed in the desired alignment between the lower part and the upper part.

The alignment is carried out by utilizing the rotational symmetry of the adapter and of the upper part or the lower part, the adapter being rotated with respect to the upper part and/or the lower part. The adapter can be aligned in one of at least two positions.

Preferably, the lower part and/or the upper part is/are welded to the adapter, in particular by infrared welding.

### BRIEF DESCRIPTION OF THE DRAWINGS

Further features and advantages of the disclosure will become apparent from the description below and from the attached drawings to which reference is made and in which:

FIG. 1 schematically shows a vehicle exhaust system comprising a sound generating device according to the disclosure,

FIG. 2 the sound generating device according to the disclosure of the vehicle exhaust system according to FIG. 1 in a perspective exploded view,

FIG. 3 a top view of an adapter of the sound generating device according to FIG. 2, and

FIGS. 4a to 4c the sound generating device according to FIG. 2, in which the adaptor is aligned in different positions with respect to a lower part of the sound generating device.

### DETAILED DESCRIPTION

“A, B and/or C” are to be understood to disclose an arbitrary combination of the alternatives, i.e. the lists are to be read as “A and/or B and/or C”. The same holds true for listings with more than two items.

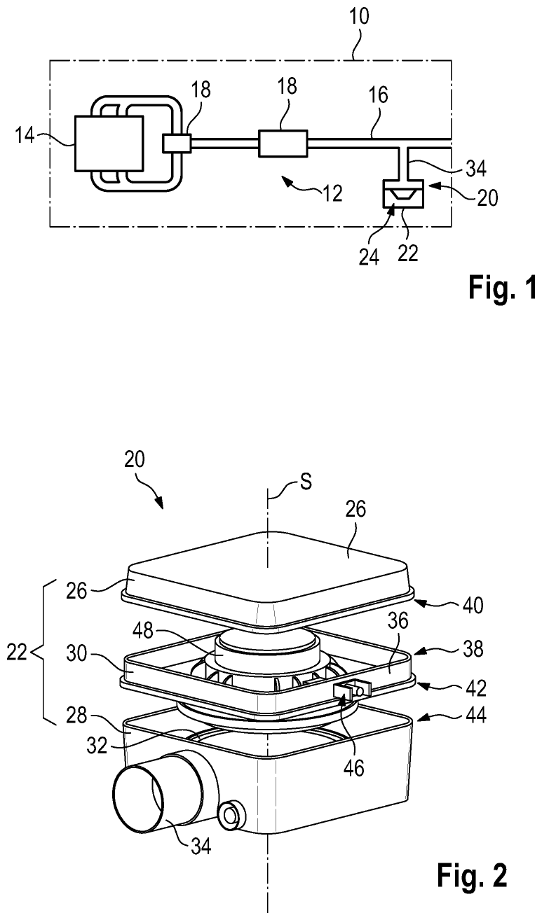

FIG. 1 schematically shows a motor vehicle 10 comprising a vehicle exhaust system 12. The vehicle exhaust system 12 directs the exhaust gas generated in the internal combustion engine 14 of the motor vehicle 10 into the environment of the motor vehicle 10.

To this end, the vehicle exhaust system 12 includes at least one exhaust pipe 16 and various exhaust-gas treatment devices 18, for example particulate filters, catalytic converters and/or silencers.

In addition, the vehicle exhaust system 12 has a sound generating device 20.

The sound generating device 20 has a housing 22 and a sound generator 24, for example a loudspeaker.

The sound generator 24 is arranged in the housing 22 and is enclosed by the housing 22 such that the sound generator 24 is accommodated in the housing 22 in a protected manner.

The sound generator 20 is acoustically connected to the exhaust pipe 16, so that sound generated by the sound generator 24 can interact with sound in the exhaust pipe 16.

The sound generating device 20 is, for example, part of an active silencer to reduce exhaust noise. In such active silencers, sound is generated by the sound generator 24 which is in phase opposition to the engine noise from the internal combustion engine 14. The engine noise in the exhaust pipe 16 is then superimposed by the sound from the sound generator 24, which cancels or at least dampens the exhaust noise.

However, such a sound generating device 20 may also be used to modify the engine noise in that further sound is produced by the sound generator 24 and added to the engine noise. The sound of a more sporty engine is thus imitated.

FIG. 2 shows the sound generating device 20 in an exploded view.

It is clearly visible that the housing 22 is made in three parts and has an upper part 26, a lower part 28, and an adapter 30.

The adapter 30 is provided between the upper part 26 and the lower part 28 and connects the upper part 26 to the lower part 28. The upper part 26 and the lower part 28 are not in direct contact with each other in the assembled state.

The upper part 26, the lower part 28, and the adapter 30 together form an outer shell of the housing 22, which in the example embodiment shown is approximately cuboid and which has a square outer contour in a horizontal section, i.e. in a section parallel to the parting plane of the upper part 26 or of the lower part 28 and the adapter 30. The corners of the square outer contour can be rounded.

It is of course also conceivable that the outer shell or the housing 22 is generally spherical or has a different shape, e.g. a circular cylindrical shape.

The outer shell delimits an interior of the housing 22, in which the sound generator 24 is provided.

For this purpose, the upper part 26 and the lower part 28 are designed as corresponding counterparts, for example as half-shells.

In the embodiment shown, different structures are located within the lower part 28, for example a wall 32 subdividing the interior of the housing 22 into a front volume and a rear volume with respect to the sound generator 24.

In addition, the lower part 28 has a sound channel 34 which starts from the interior of the housing 22, more precisely from the front volume. The sound channel 34 opens into the exhaust pipe 16 to acoustically connect the sound generating device 20 to the vehicle exhaust system 12.

The adapter 30 has a frame 36 which is used to fasten the lower part 28 to the upper part 26.

For this purpose, the frame 36 has an upper coupling portion 38 at its end facing the upper part 26, and the upper part 26 has a connecting portion 40 at its end facing the adapter 30, which is designed to be complementary to the upper coupling portion 38.

In the example embodiment shown, the upper coupling portion 38 of the frame 36 is configured as a single edge, and the connecting portion 40 of the upper part 26 is configured as a circumferential groove in which the edge of the upper coupling portion 38 engages, or as a collar against which the edge rests.

The edge can then be welded to the collar or the groove, in particular by infrared welding.

The adapter 30 is similarly connected to the lower part 28.

For this purpose, the frame 36 has a lower coupling portion 42 at its end facing the lower part 28, and the lower part 28 has a connecting portion 44 at its end facing the adapter 30.

The connecting portion 44 of the lower part 28 is configured as an edge, and the lower coupling portion 42 of the adapter 30 is configured as a groove or as a collar.

Due to the square outer contour of the housing 22, the connecting portions 40, 44, the upper coupling portion 38 and the lower coupling portion 42 are also square. They therefore have a rotational symmetry about a common axis of symmetry S, which is perpendicular to the parting planes between the adapter 30 and the upper part 26 or between the adapter 30 and the lower part 28 and which runs through the center of the square contour.

The adapter 30 can thus be connected in four different positions to the lower part 28 and in four different positions to the upper part 26.

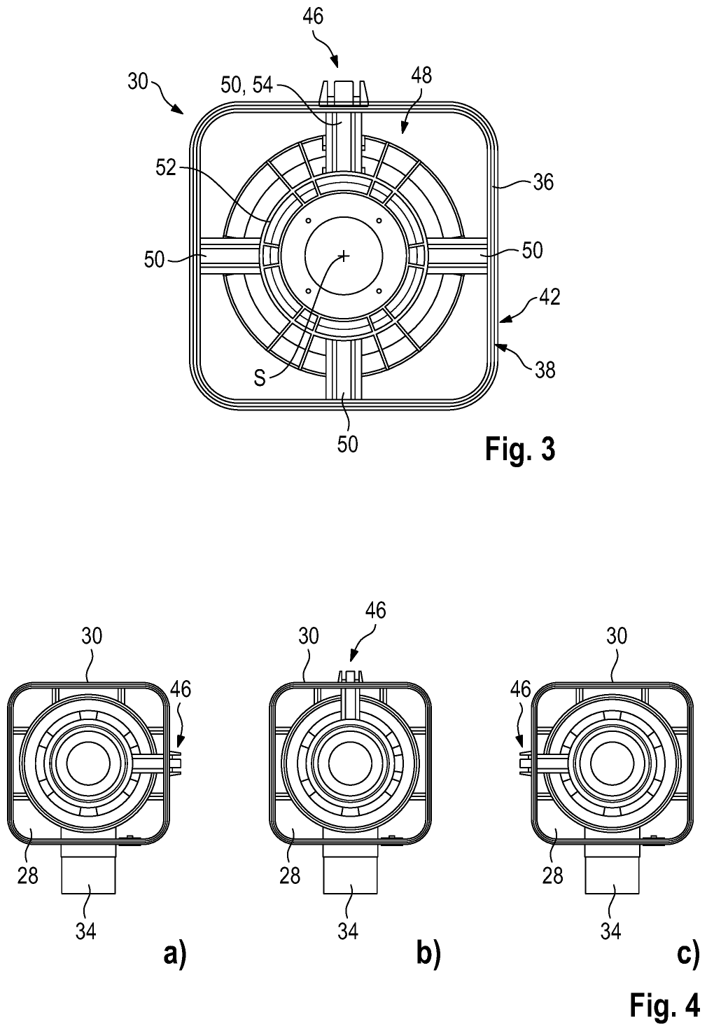

FIG. 3 shows the adapter 30 in a top view.

The adapter 30 comprises the frame 36, a plug connection 46, a holder 48 for the sound generator 24, and spokes 50.

The spokes 50 are not shown in FIGS. 2 and 4 for reasons of clarity.

In the embodiment shown, the entire adapter 30 is made in one piece such that the frame 36, the holder 48, the spokes 50, and the plug connection 46 are formed in one piece with each other.

The frame 36 also has an outer contour which corresponds to the contour of the outer shell of the housing 22, and it forms a complete circumference of the housing 22 or of the outer contour.

In the example embodiment shown, the frame 36 thus has a square outer contour, the rectangle or the square of the outer contour having rounded corners.

The frame 36 is therefore rotationally symmetrical about the axis of symmetry S, which is also perpendicular to the plane spanned by frame 36 and which runs through the center of the frame 36.

In the case of a round outer contour of the housing 22, the frame 36 can also be ring-shaped or have a circular outer contour.

The upper part 26, the lower part 28, and the adapter 30 are then, for example, substantially circular-cylindrical, resulting in a correspondingly large number of different positions in which the parts of the housing 22 can be connected to each other. The plug connection 46 can thus also be provided in different positions.

The holder 48 has a holding portion 52 for the sound generator 24, which for example, completely surrounds the chassis of the sound generator 24.

The holding portion 52 is ring-shaped, and the sound generator 24 is fastened to the holding portion 52, thus fixing the entire sound generator 24 in the housing 22.

The holder 48 or the holding portion 52 are arranged radially symmetrically about the center of the frame 36 such that the frame 36 completely surrounds the holder 48 and the holding portion 52.

The holding portion 52, in particular the entire holder 48, is arranged in the plane spanned by the frame 36.

In the embodiment shown, four spokes 50 are provided which are evenly distributed about the circumference of the holder 48.

The spokes 50 extend radially outwards from the holder 48 to the frame 36.

The spokes 50 respectively meet the frame 36 in the middle of the sides of the outer contour of the frame 36.

The plug connection 46 is provided on one of the sides of the frame 36.

The plug connection 46 is thus formed separately from the upper part 26 and from the lower part 28 and serves as an electrical interface between the interior of the housing 22 and the environment of the housing 22.

The plug connection 46 is arranged on the radial outside of the frame 36 and includes a fastener to fasten a plug.

In the mounted state of the housing 22, the plug connection 46 protrudes outwards from the outer shell of the housing 22, in particular radially outwards as seen from the ring-shaped holding portion 52.

At least one control cable (not shown), for example, extends from the plug connection 46 to the sound generator 24, for example through or along one of the spokes 50, which in this case is formed as a cable routing 54 or includes the cable routing 54.

In the embodiment shown, the plug connection 46 is, for example, located at the point of one side where the associated spoke 50 meets the side. This spoke 50 can then simultaneously form the cable routing 54.

In FIG. 3, it therefore looks as if the plug connection 46 forms the extension of the associated spoke 50.

Due to the rotational symmetry of the lower coupling portion 42 and of the connecting portion 44, the adapter 30 can be fastened to the lower part 28 in various positions.

Three of these positions are shown in FIG. 4. It is clearly visible that the different positions of the adapter 30 with respect to the upper part 26 result in the plug connection 46 being adapted to be arranged in different positions with respect to the sound channel 34. In the example embodiment shown, it is therefore possible to realize four different positions of the plug connection 46 with respect to the sound channel 34.

Of course, other contours of the frame 36 are also conceivable, which lead to other rotational symmetries and thus possibly to more or less positions of the plug connection 46.

Due to the different positions of the plug connection 46, it is possible to manufacture sound generating devices 20 for different installation positions using the same components, so that the manufacturing costs are reduced.

To manufacture the sound generating device 20, the adapter 30 is first aligned with respect to the lower part 28 or the upper part 26 such that the plug connection 46 is in the desired position, i.e. on the desired side of the housing 22.

Alignment therefore means a rotation of the adapter 30 relative to the lower part 28 or the upper part 26, which is possible due to the rotational symmetry of the connecting portions 40, 44 and of the upper or lower coupling portion 38, 42.

The lower coupling portion 42 is then welded to the connecting portion 44 of the lower part 28, in particular by infrared welding, and the upper coupling portion 38 is welded to the connecting portion 40 of the upper part 26, in particular also by infrared welding.

In general, the adapter 30 and the sound generator 24 together can form a unit and can in particular be made in one piece. The housing of the sound generator 24 is coupled, for example, to the adapter 30, in particular to the holder 48 or the holding portion 52. In particular, the housing of the sound generator 24 and the adapter 30 are formed in one piece, for example by being manufactured together in an injection molding process. The adapter 30, in particular the holder 48 of the adapter 30, can therefore be considered as a part of the sound generator 24, in particular as a part of the housing of the sound generator 24.

Although various embodiments have been disclosed, a worker of ordinary skill in this art would recognize that certain modifications would come within the scope of this disclosure. For that reason, the following claims should be studied to determine the true scope and content of this disclosure.

1. A sound generating device for a vehicle exhaust system of a motor vehicle, including;
a housing; and
a sound generator arranged within the housing,
the housing having an upper part, a lower part, and a plug connection for at least one control cable for the sound generator, the plug connection being arranged between the upper part and the lower part.

2. The sound generating device according to claim 1, wherein the housing has an adapter on which the plug connection is formed, the upper part being connected to the lower part via the adapter.

3. The sound generating device according to claim 2, wherein the adapter has at least one coupling portion and in that at least one of the upper part and the lower part has/have a connecting portion associated with the at least one coupling portion.

4. The sound generating device according to claim 3, wherein at least parts of the adapter and at least parts of at least one of the upper part and of the lower part are formed rotationally symmetrical about a common axis of symmetry such that the at least one of the upper part and/or the lower part can be fastened to the adapter in different positions.

5. The sound generating device according to claim 3, wherein the adapter has an upper coupling portion which faces the upper part, and a lower coupling portion which faces the lower part.

6. The sound generating device according to claim 2, wherein the adapter has at least one frame.

7. The sound generating device according to claim 6, wherein the adapter has at least one coupling portion and in that at least one of the upper part and the lower part has/have a connecting portion associated with die at least one coupling portion, and wherein the at least one coupling portion is formed on the frame.

8. The sound generating device according to claim 6, wherein the frame has a circular or a substantially rectangular outer contour.

9. The sound generating device according claim 2, wherein the adapter has a holder for the sound generator, the sound generator being fastened to the housing via the holder.

10. The sound generating device according to claim 9, wherein the adapter has at least one frame, and wherein the holder has a holding portion for the sound generator which is completely surrounded by the at least one frame.

11. The sound generating device according to claim 9, wherein the adapter has at least one frame, and wherein a cable routing extends from the holder to the at least one frame.

12. The sound generating device according to claim 11, wherein the adapter has at least one frame, and wherein the holder and the at least one frame lie in tire same plane.

13. The sound generating device according claim 2, wherein the adapter and the sound generator form a unit.

14. A vehicle exhaust system comprising:
a sound generating device including a housing and a sound generator arranged within the housing, the housing having an upper part, a lower part, and a plug connection for at least one control cable for the sound generator, the plug connection being arranged between the upper part and the lower part; and
an exhaust pipe that is acoustically connected to the sound generating device.

15. A method of manufacturing a sound generating device for a vehicle exhaust system of a motor vehicle, in which a lower part, an upper part, and an adapter having a plug connection are provided, wherein at least the adapter is aligned with respect to at least one of the lower part and to the upper part such that the plug connection is provided on a desired side of the sound generating device to be manufactured, and wherein the adapter is placed in the desired alignment between the lower part and the upper part.

16. The method according to claim 19, wherein at least one of the lower part and the upper part are welded to the adapter.

17. The sound generating device according to claim 4, wherein the at least parts of the adapter comprises the at least one coupling portion.

18. The sound generating device according to claim 4, wherein the at least parts of at least one of the upper part and of the lower part are the respective connecting portion.

19. The sound generating device according to claim 11, wherein the cable routing extends up to the plug connection.

20. The vehicle exhaust system according to claim 14, wherein the exhaust pipe is acoustically connected to an interior of the housing via a sound channel.
